(19) United States
(12) Patent Application Publication
(10) Pub. No.: US 2011/0101199 A1
(43) Pub. Date: May 5, 2011

(54) Magnetic soap holder

(76) Inventor: Brucelina Andrade, Cranston, RI (US)

(21) Appl. No.: 12/924,943

(22) Filed: Oct. 8, 2010

Related U.S. Application Data
(60) Provisional application No. 61/279,037, filed on Oct. 16, 2009.

(51) Int. Cl. A47G 29/08; H01F 7/02

(52) U.S. Cl. 248/686

(57) ABSTRACT

The device of the present application is essentially a soap-holding device that suspends the bar of soap from the top surface as opposed to placing it down. The primary objective of this device is to receive various bars of soap through the implementation of a magnet, in a way that prevents them from creating soap-scum and from accumulating harmful bacteria that can form on dirty and unsanitary surfaces. It also creates an intriguing atmosphere to the bathroom or kitchen, while adding a little fun and excitement to washing with bar soap.

### CROSS REFERENCE TO RELATED APPLICATIONS

This application claims priority from provisional patent application No. 61/279,037 Filed on Oct. 16, 2009 directed to a Magnetic Soap Holder that is herby incorporated by reference.

### STATEMENT REGARDING FEDERALLY SPONSORED RESEARCH OR DEVELOPMENT

No federally related funds were used in the development of the device of the present invention.

### BACKGROUND OF THE INVENTION

1. Field of the Invention

This invention relates to magnetic soap holders, specifically to such holders that are magnetic memorable of suspending soap over a sink basin.

2. Brief Description of the Prior Art

Magnetic Soap Holders are well known in the art. For example U.S. Pat. Nos. D458493, D249207, D341049, 3472391, and D277820 all disclose and claims various DESIGNS for soap holders including magnetic soap holders. The presence of these patents in the prior art demonstrates that it is generally known to construct Magnetic Soap Holders.

In addition to that U.S. Pat. No. 6,929,232 to Gasperi, Gasperi and Cascio directed to a MAGNETIC SOAP HOLDER discloses and claims a magnetic soap holder comprising a substantially vertical portion and a substantially horizontal portion. Under the teaching of the Gasperi, Gasperi and Cascio patent, the horizontal portion extends upwardly and outwardly from the vertical portion and includes a horizontal end portion.

U.S. Pat. No. 5,417,397 to Harnett discloses and claims an improved magnetic soap holder for suspending a bar of soap and, if desired, utensils so that each may dry. The Harnett improved magnetic soap holder includes a soap-holding magnet used to attract the soap-holding plate, which is imbedded into a bar of soap. Under the teaching of Harnett patent, the soap-holding magnet is placed in a soap-holding-magnet housing to concentrate the magnetic force thus allowing a magnetic pull through a greater distance.

U.S. Pat. No. 3,552,705 to Caster discloses and claims a holder for cake or bar soap including a magnet embedded within the holder for magnetic attachment to an armature in the form of a metal disc secured to and preferably embedded in and flush with a wall or other support, and a second magnet embedded within the holder for independently supporting a bar of soap also having an armature embedded therein. Under the teaching of the Caster patent, the combination holder and bar soap is adapted for singlehanded operation in attaching the holder to a support and in detaching the soap from the holder without disturbing the attachment of the holder.

U.S. Pat. No. 4,309,014 to Blaszkowski discloses and claims a soap bar and holder therefore wherein the soap bar has a centrally aperture plastic insert embedded therein and the holder has a rubber suction cup base for mounting on a suitable surface and a shank having a free end portion adapted to receive the plastic insert in the soap bar so as to support the soap bar with the shank in either a horizontal, inclined or upright position. Under the teaching of Blaszkowski patent, The soap bar is adapted to be retained on the holder either loosely or in a stable condition so that one's hands may be rubbed over the soap bar while the bar remains on the holder and the bar may also be removed from the holder and used in the manner of a conventional bar of soap.

U.S. Pat. No. 5,642,871 to Repert and Repert discloses and claims a suspendable magnetic soap holder assembly for magnetically suspending a bar of soap from a raised holding member includes a flexible suspender interconnected with a first member of a pair of mutually attracting devices and a bar of soap removable interconnected with a second member of the pair of mutually attracting devices. When the flexible suspender is coupled to the raised holding member and the pair of mutually attracting devices are interconnected, the bar of soap is suspended. In one embodiment, the pair of mutually attracting devices are a magnet and a metallic device.

Despite all the efforts listed above prior art patents describe structures that are either not truly convenient to use or else involve complicated, expensive, and overly difficult assembly and/or disassembly parts and procedures. Other devices have been advertised on various media but never patented or described into a printed publication.

### SUMMARY OF THE INVENTION

The device of the present invention consist of a magnetic soap holder comprising a substantially vertical portion and a substantially horizontal portion. The vertical portion being horizontally mountable to a flat surface and extending upwardly and outwardly from a base. The horizontal portion extends upwardly and outwardly from the vertical portion and includes a horizontal end portion. The horizontal end portion having a top surface and a flat bottom surface. A magnet is attached to the bottom surface for magnetically attracting a magnetic member pressed into a bar of soap, thereby suspending the bar of soap above a tub or sink basin

It is then the primary objective of this device is to receive various bars of soap in a way that prevents them from creating soap-scum and from accumulating harmful bacteria that can form on dirty and unsanitary surfaces. For example, if a person wash their hands then they leave a soap bar on the sink the residual water tent to dissolve the outer layer of the soap bar that ultimately collects into a soap holder eventually re-crystallizing under form of solid soap. Eventually the outer layer of a soap bar is the one that gets in contact with the skin during the hands-washing process and that collects all the grease, bacteria, viruses, sweat, dirt, blood, saliva, scum, and other undesirable particles that then collects on the bottom of the soap holder giving a characteristic dirty gray colors.

By using the magnetic soap holder of the present application the soap is literally suspended from the bottom avoiding all the negative effects mentioned above. It is the a secondary objective of the present invention to provide for a device that creates a clean and intriguing atmosphere to the bathroom or kitchen, while adding a little fun and excitement to washing with bar soap. It is an additional objective of the present invention to provide for an ornamental household article that is pleasant to see and display.

It is an additional objective of the present invention to provide a device that does not rust, or deteriorates in the humid high moist and hot conditions of a bathroom. It is a final objective of the present invention to provide for a device that is cheap to build, but that can eventually be sold at a premium.

These and other objective achieved by the device of the present invention will be apparent by the drawings, by their detailed description, and by the specification here from and from the claims appended.

### BRIEF DESCRIPTION OF THE DRAWINGS

FIG. 1 is a perspective view of the Magnetic Soap Holder in accordance with the teachings of the present invention;

FIG. 2 is a right perspective view of Magnetic Soap Holder of FIG. 1 and all its features;

FIG. 3 is a top perspective view of Magnetic Soap Holder of FIG. 1 unassembled.

FIG. 4 Is a view of Magnetic Soap Holder mounted on the wall without the stand support;

FIG. 5 is a view of Magnetic Soap Holder on the wall wich gives this invention a unique future to be use it 2 ways: 1. Magnetic Soap Holder standing on any top counter; 2. magnetic Soap holder mounted on the wall just using the main base and the wall mount to suspend any type of soap.

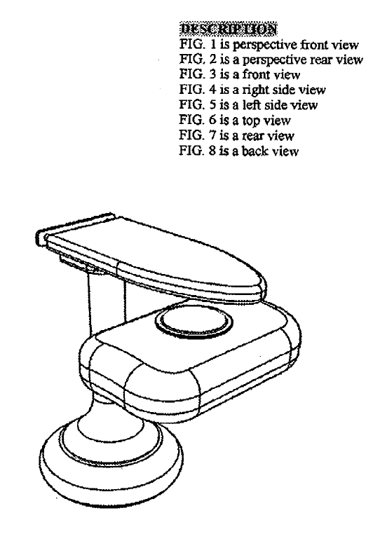

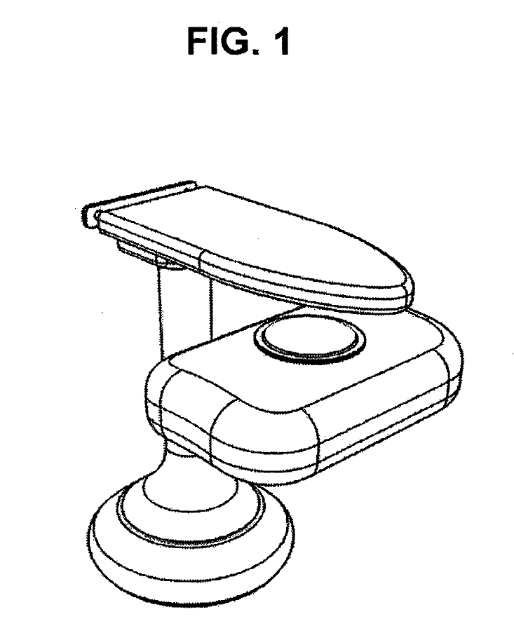

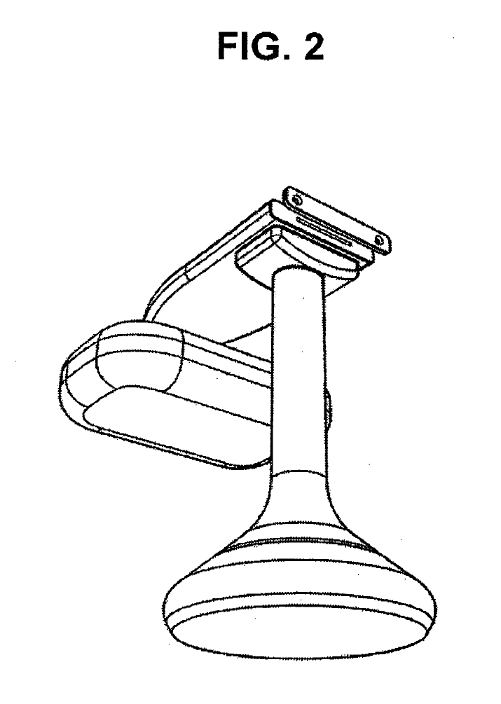

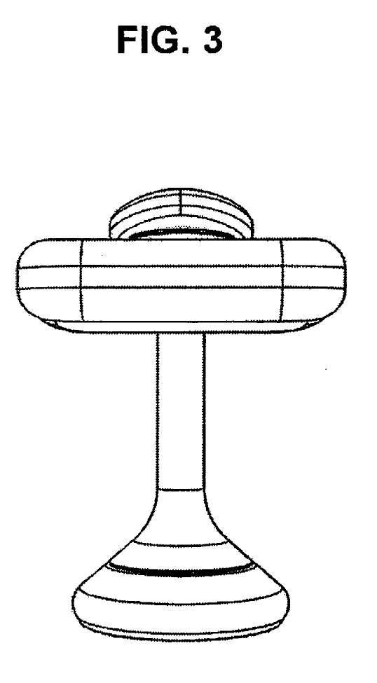

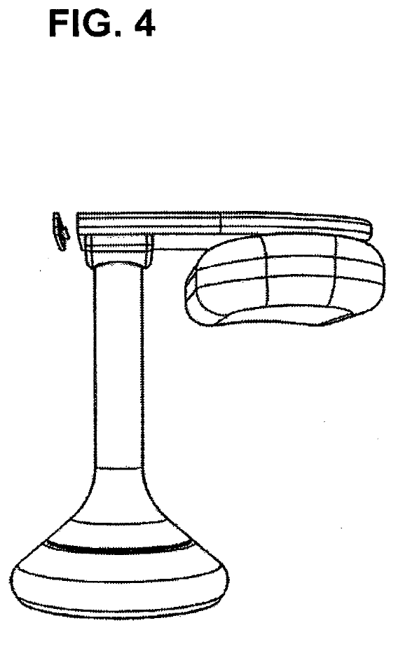

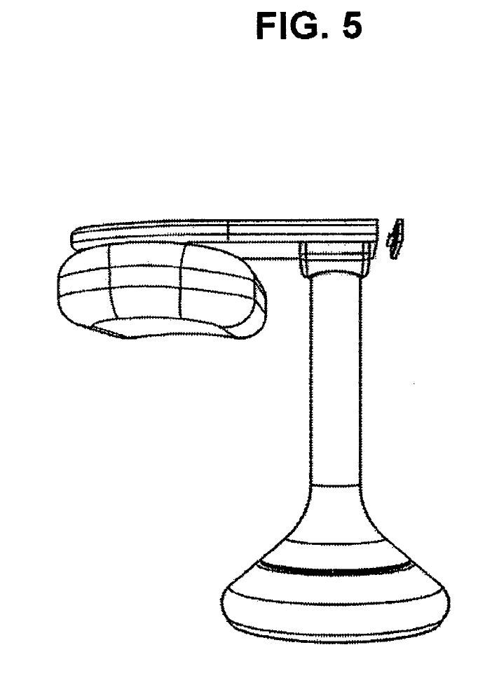

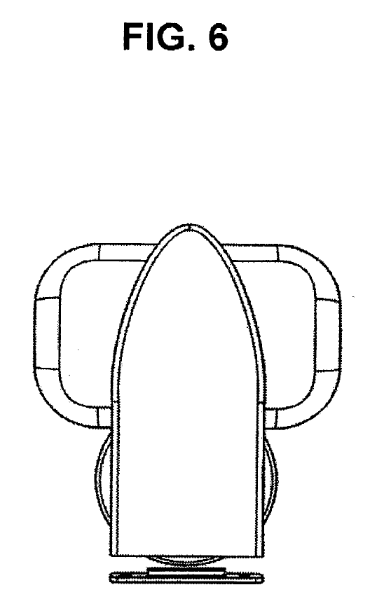

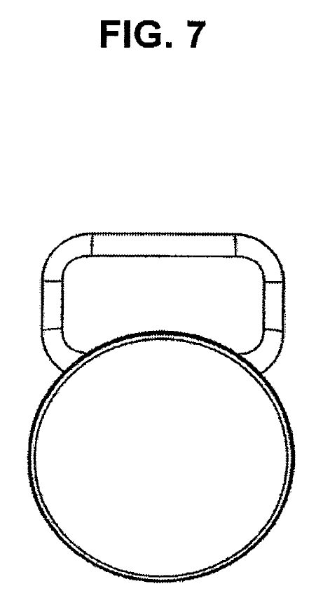

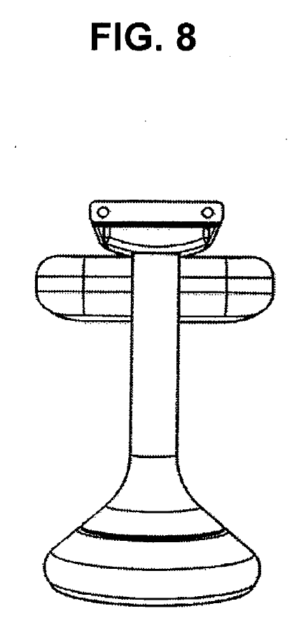

### DESCRIPTION OF THE PREFERRED EMBODIMENT

As it can be seen from the drawings the device of the present invention is essentially a soap-holding device that suspends the bar of soap from the top surface as opposed to placing it down. Also the same device can be use differently by placing the wall mount plate on the wall and slide the main base in witch will give a different method of using the device without the stand.

What gives the “Magnetic Soap Holder” its' ornamental and unique characteristic is how the bar of soap is suspended. The suspension mechanism is a magnet which is embedded in the superior surface of the soap. When the soap is not in use, a metal bracket which serves as a port for the soap acts as an overhang perpendicular to the bar of soap and receives the magnet in the soap; thus, allowing the soap to be suspended from above.

Materials for manufacturing include but are not limited to plastic, magnets, metal such as Aluminum, Stainless Steel, Sterling Silver, Iron, or any other similar materials and plastics.

The drawings generally shown that the device of the present invention is a magnetic soap holder comprising a support member, a base member, and a couple of opposing poles magnets, a first magnet and a second magnet, one of which is permanently attached to said horizontal base member and the other one is inserted into a soap bar regardless of their polarity.

In a first preferred embodiment of the magnetic soap holder of the present invention said support member is a vertical stand but in an alternative embodiment said support member is a Wall mount plate. Additionally is a second preferred embodiment of the present invention said base member and said support member are connected by removable pins.

The connection between the soap and the magnet depends of the most practical solution for the situation. Said first magnet is permanently attached into said horizontal base member and said second magnet is permanently inserted into a soap bar or vice versa said second magnet is permanently attached into said horizontal base member and said first magnet is permanently inserted into a soap bar. In this embodiment the magnetic is permanently melted or glued inside the soap bar.

In a different embodiment one of the magnets is attached on a clip that in turn is attached to a soap bar in a fashion where said first magnet is permanently attached into said horizontal base member and said second magnet is removable inserted into a soap bar as a magnetic soap clip or alternatively where one of said first magnet is permanently attached into said horizontal base member and said second magnet is removable inserted into a soap bar as a magnetic soap clip.

Said base member is generally horizontal, but it can be positioned at an angle generally that is generally positive (going upwardly from the base member toward the sky) or negative (going downwardly from the support member toward the ground).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A magnetic soap holder comprising a support member, a base member, and a couple of opposing poles magnets, a first magnet and a second magnet, one of which is permanently attached to said horizontal base member and the other one is inserted into a soap bar regardless of their polarity.

2. The magnetic soap holder of claim one where said support member is a vertical stand.

3. The magnetic soap holder of claim two where said vertical support member and said horizontal base member are connected by removable pins.

4. The magnetic soap holder of claim one where one of said first magnet is permanently attached into said horizontal base member and said second magnet is permanently inserted into a soap bar.

5. The magnetic soap holder of claim one where one of said second magnet is permanently attached into said horizontal base member and said first magnet is permanently inserted into a soap bar.

6. The magnetic soap holder of claim one where one of said first magnet is permanently attached into said horizontal base member and said second magnet is removably inserted into a soap bar as a magnetic soap clip.

7. The magnetic soap holder of claim one where one of said second magnet is permanently attached into said horizontal base member and said first magnet is removably inserted into a soap bar as a magnetic soap clip.

8. The magnetic soap holder of claim one where said support member is a Wall mount plate.

9. The magnetic soap holder of claim one where said base member is generally horizontal.

10. The magnetic soap holder of claim one where said base member is generally positioned at a positive angle with respect to the ground.

11. The magnetic soap holder of claim one where said base member is generally positioned at a negative angle with respect to the ground.

12. The magnetic soap holder of claim one where said base member is cantilevered by said support member.
